(19) United States
(12) Patent Application Publication
(10) Pub. No.: US 2025/0246324 A1
(43) Pub. Date: Jul. 31, 2025

(54) NOISE REDUCTION APPARATUS FOR CONTROL ROD POSITION INDICATOR

(71) Applicants: KEPCO ENGINEERING & CONSTRUCTION COMPANY, INC., Gimcheon-si (KR); KOREA HYDRO & NUCLEAR POWER CO., LTD, Gyeongju-si (KR)

(72) Inventors: Won Ho LEE, Yuseong-gu (KR); Jin Seok PARK, Sejong-si (KR); Seungyoung AHN, Yuseong-gu (KR); Sang Uk LEE, Yuseong-gu (KR)

(21) Appl. No.: 19/016,533

(22) Filed: Jan. 10, 2025

(30) Foreign Application Priority Data
Jan. 30, 2024 (KR) 10-2024-0014340

(51) Int. Cl. G21C 17/10; G01D 5/20

(52) U.S. Cl. CPC G21C 17/10; G01D 5/2013

(57) ABSTRACT

A noise reduction apparatus for a control rod position includes a control rod driving shaft connected to a control rod and configured to move in an up-and-down direction, a drive unit configured to move the control rod driving shaft and including a driving coil surrounding an outside of the control rod driving shaft, a solenoid spaced apart from the drive unit and surrounding the outside of the control rod driving shaft, wherein inductance of the solenoid changes due to a movement of the control rod driving shaft, and a reduction coil configured to reduce noise transmitted from the driving coil to the solenoid.

### CROSS-REFERENCE TO RELATED APPLICATION

This application is based on and claims priority under 35 U.S.C. § 119 to Korean Patent Application No. 10-2024-0014340, filed on Jan. 30, 2024, in the Korean Intellectual Property Office, the disclosure of which is incorporated by reference herein in its entirety.

### BACKGROUND

### 1. Field

The disclosure relates to a noise reduction apparatus for a control rod position indicator, and more particularly, to a noise reduction apparatus for a control rod position indicator, the apparatus being capable of reducing noise generated by a driving coil by using a reduction coil in the control rod position indicator having a solenoid capable of continuously measuring a control rod position.

### 2. Description of the Related Art

Control rods are located within a reactor core to control the power output of a nuclear power plant. In a nuclear reactor, control rod drive units control the vertical movement of the control rods inside the reactor core in response to control signals, thereby regulating core reactivity. Therefore, the positional information of the control rods is a very crucial factor in the design of a reactor system.

In the related art, a reed switch and a permanent magnet are used to measure the position of a control rod. The control rod is fastened to the lower end of a control rod driving shaft to move in an up-and-down direction inside the reactor core in response to an up-and-down motion of the control rod driving shaft, and the reed switch may be opened or closed by the permanent magnet mounted on the upper end of the control rod driving shaft. Since the configuration and operation of the reed switch are already known, a detailed description thereof will be omitted.

Multiple reed switches may be arranged in a reactor system, and the position of the control rod may be measured through the operation of the multiple reed switches. However, in the related art, the position indicator for measuring the position of the control rod through the reed switches, according to the related art, has an issue of discretely measuring the position of the control rod.

Specifically, since the multiple reed switches are arranged in a line, resolution less than or equal to the length of the reed switches cannot be obtained, and thus, the position of the control rod is discretely measured. As such, when the position of the control rod is discretely measured, there is a disadvantage in that precision above a certain level cannot be achieved due to structural limitations.

In addition, in the related art, a method of measuring the position of the control rod by using multiple solenoids is used. Specifically, in the method of measuring the position of the control rod through multiple solenoids, the inductance of the multiple solenoids changes due to a movement of a control rod driving shaft.

However, in this method of using multiple solenoids, the position of the control rod is also discretely measured, and thus, precision above a certain level cannot be achieved due to structural limitations.

### SUMMARY

Provided is a noise reduction apparatus for a control rod position indicator, the apparatus being capable of reducing noise generated by a driving coil by using a reduction coil in the control rod position indicator having a solenoid capable of continuously measuring a control rod position.

Additional aspects will be set forth in part in the description which follows and, in part, will be apparent from the description, or may be learned by practice of the presented embodiments of the disclosure.

A noise reduction apparatus for a control rod position indicator, according to an embodiment, is capable of measuring a position of a control rod.

According to an aspect of the disclosure, a noise reduction apparatus for a control rod position indicator includes a control rod driving shaft connected to a control rod and configured to move in an up-and-down direction, a drive unit including a driving coil surrounding an outside of the control rod driving shaft and configured to move the control rod driving shaft, a solenoid spaced apart from the drive unit and surrounding the outside of the control rod driving shaft, wherein inductance of the solenoid is varied by a movement of the control rod driving shaft, and a reduction coil configured to reduce noise transmitted from the driving coil to the solenoid.

One solenoid extending in a longitudinal direction may be provided outside the control rod driving shaft of the noise reduction apparatus for a control rod position indicator, according to an embodiment, and the one solenoid may continuously measure a position of the control rod driving shaft through changes in the inductance of the one solenoid.

The control rod driving shaft of the noise reduction apparatus for a control rod position indicator, according to an embodiment, may include a magnetic material and the inductance of the solenoid may be varied in response to movement of the control rod driving shaft.

The reduction coil of the noise reduction apparatus for a control rod position indicator, according to an embodiment, may be provided between the solenoid and the driving coil.

The reduction coil of the noise reduction apparatus for a control rod position indicator, according to an embodiment, may include a magnetic shielding coil surrounding the control rod driving shaft and cancelling out a magnetic field generated from the driving coil.

No current may be applied to the magnetic shielding coil of the noise reduction apparatus for a control rod position indicator, according to an embodiment.

A current having a phase opposite to that of a current applied to the driving coil may be applied to the magnetic shielding coil of the noise reduction apparatus for a control rod position indicator, according to an embodiment.

The reduction coil of the noise reduction apparatus for a control rod position indicator, according to an embodiment, may include a magnetic permeability control coil surrounding the control rod driving shaft, and a direct current (DC) may be applied to the magnetic permeability control coil.

The drive unit of the noise reduction apparatus for a control rod position indicator, according to an embodiment, may include a driving motor including an electromagnet, and the driving coil may surround the driving motor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating one solenoid provided outside a control rod driving shaft according to an embodiment, wherein a position of the control rod driving shaft is continuously measured through changes in inductance of the one solenoid;

FIG. 2 is a view illustrating a magnetic shielding coil provided between a solenoid and a driving coil, according to an embodiment;

FIG. 3 is a diagram illustrating a magnetic permeability control coil which is arranged between a solenoid and a driving coil and to which a direct current (DC) is applied, according to an embodiment; and

FIG. 4 is a diagram illustrating a magnetic shielding coil and a magnetic permeability control coil which are provided between a solenoid and a driving coil, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

This specification describes the principles of the disclosure and discloses embodiments to clarify the scope of the disclosure and to enable one of ordinary skill in the art to practice the disclosure. The disclosed embodiments may be implemented in various forms.

The term “include” or “may include” which may be used in various embodiments of the disclosure indicates the presence of a corresponding function, operation, or component, and the like, and does not limit additional one or more functions, operations, or components. Further, in various embodiments of the disclosure, it should be understood that the terms “comprise” or “have” and the like are intended to designate the presence of the features, numbers, steps, actions, components, parts, or combinations thereof described herein, and are not intended to preclude the possibility of the presence or addition of one or more other features, numbers, steps, actions, components, parts, or combinations thereof.

When a component is referred to as being “connected, coupled” to another component, it should be understood that the component may be directly connected or coupled to the other component, but a new component may exist between the component and the other component. On the other hand, when a component is referred to as being “directly connected” or “directly coupled” to another component, it should be understood that no new other component exists between said component and said other component.

Terms such as “first” and “second” used in the present specification may be used to describe various components, but the components should not be limited by the terms. The terms are used solely to distinguish one component from another.

The disclosure relates to a noise reduction apparatus for a control rod position indicator, and more particularly, to a noise reduction apparatus for a control rod position indicator, the apparatus being capable of reducing noise generated from a driving coil by using a reduction coil in the control rod position indicator including a solenoid capable of continuously measuring a control rod position.

The noise reduction apparatus for a control rod position indicator, according to an embodiment, may be applied to a small modular reactor (SMR). However, the disclosure is not limited thereto, and the noise reduction apparatus for a control rod position indicator, according to an embodiment, may be applied to various nuclear reactors. Hereinafter, preferred embodiments will be described in detail with reference to the attached drawings.

The noise reduction apparatus for a control rod position indicator, according to an embodiment, may include a control rod driving shaft 120, a drive unit 130, a solenoid 140, and a reduction coil 150.

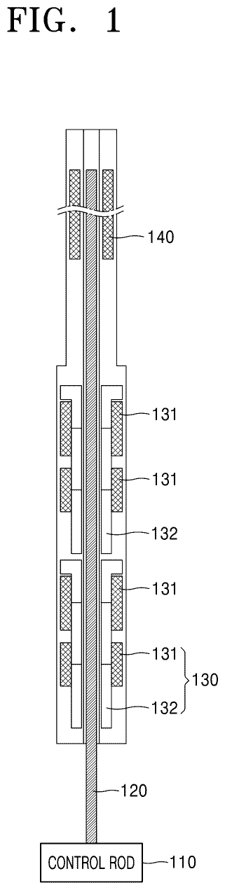

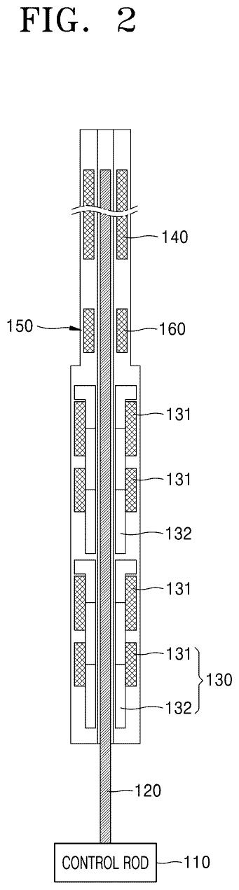

Referring to FIGS. 1 and 2, the control rod driving shaft 120 according to an embodiment may move up and down while being connected to the control rod 110.

The control rod 110 may be placed in a core of a reactor to control the output of a nuclear power plant, and the control rod 110 may be connected to a lower portion of the control rod driving shaft 120.

The control rod 110 may move in a vertical direction inside the core of the reactor according to a control signal, and the core reactivity may be adjusted according to a movement of the control rod 110.

The control rod 110 may move together with the control rod driving shaft 120, and by adjusting a position of the control rod driving shaft 120, a position of the control rod 110 inside the core may be adjusted.

The control rod driving shaft 120 may extend in a longitudinal direction or the vertical direction, and the control rod 110 may be connected to the lower portion of the control rod driving shaft 120. The control rod driving shaft 120 may move in an up-and-down direction or in the vertical direction, and the position of the control rod 110 may be shifted by the movement of the control rod driving shaft 120.

The drive unit 130 may move the control rod driving shaft 120, and the drive unit 130 may include a driving coil 131 surrounding the outside of the control rod driving shaft 120.

The driving coil 131 may be a coil surrounding the outside of the control rod driving shaft 120, and the driving coil 131 may form a magnetic field to move the control rod driving shaft 120 in the up-and-down direction.

According to an embodiment, the drive unit 130 may include a driving motor 132 including an electromagnet. Referring to FIG. 1, the driving motor 132 is provided outside the control rod driving shaft 120, and the driving motor 132 may be connected to the control rod driving shaft 120.

According to an embodiment, the control rod driving shaft 120 may move in the up-and-down direction by operation of the driving motor 132 connected to the control rod driving shaft 120.

According to an embodiment, the driving coil 131 may be disposed to surround the driving motor 132. Upon formation of a magnetic field by the driving coil 131, the driving motor 132 including the electromagnet may be driven, and the driving motor 132 may move in the up-and-down direction of the control rod driving shaft 120 by operation of the driving motor 132.

Referring to FIG. 1, the solenoid 140 may surround the outside of the control rod driving shaft 120 while being spaced apart from the drive unit 130. The solenoid 140 may be a coil surrounding the outside of the control rod driving shaft 120, and the solenoid 140 may be spaced apart from the drive unit 130.

According to an embodiment, inductance of the solenoid 140 may be varied by the movement of the control rod driving shaft 120. According to an embodiment, the control rod driving shaft 120 may include a magnetic material, and the inductance of the solenoid 140 may be varied in response to the movement of the control rod driving shaft 120.

Specifically, when the control rod driving shaft 120 moves in the up-and-down direction, the inductance of the solenoid 140 may be varied by the control rod driving shaft 120 including a magnetic material.

As the inductance of the solenoid 140 is varied by the movement of the control rod driving shaft 120 in the up-and-down direction, the position of the control rod driving shaft 120 may be measured through changes in the inductance of the solenoid 140.

Referring to FIG. 1, one solenoid 140 extending in the longitudinal direction may be provided outside the control rod driving shaft 120 according to an embodiment. The one solenoid 140 according to an embodiment may continuously measure the position of the control rod driving shaft 120 through the changes in inductance thereof.

According to the related art, the position of a control rod is measured through a reed switch and a permanent magnet or through multiple solenoids. However, in the method of measuring the position of a control rod through the reed switch and the permanent magnet or through the multiple solenoids, the position of the control rod is measured discretely. When the position of the control rod is discretely measured, there is a disadvantage in that precision beyond a certain level cannot be achieved due to structural limitations.

The noise reduction apparatus for a control rod position indicator, according to an embodiment, is designed to address the disadvantage of discretely measuring the position of the control rod 110 and allows the position of the control rod 110 to be continuously measured through the one solenoid 140.

Specifically, the one solenoid 140 according to an embodiment is capable of continuously measuring the position of the control rod driving shaft 120 through the changes in inductance of the solenoid 140.

When continuously measuring the position of the control rod driving shaft 120 through the one solenoid 140 according to an embodiment, noise may be generated by the driving coil 131 that moves the control rod driving shaft 120.

Specifically, the noise caused by a magnetic field generated by the driving coil 131 may affect the solenoid 140 which is capable of continuously measuring the position of the control rod driving shaft 120, which may result in an error in measuring the position of the control rod driving shaft 120.

In addition, the permeability of the control rod driving shaft 120 may change over time due to a current flowing in the driving coil 131, and accordingly, a measurement error may occur when the position of the control rod driving shaft 120 is measured using the solenoid 140.

To address this issue, the noise reduction apparatus of a control rod position indicator, according to an embodiment, may include the reduction coil 150. The reduction coil 150 may reduce noise transmitted from the driving coil 131 to the solenoid 140, and the reduction coil 150 may be a coil surrounding the outside of the control rod driving shaft 120.

The reduction coil 150 according to an embodiment may be provided between the solenoid 140 and the driving coil 131. By providing the reduction coil 150 between the solenoid 140 and the driving coil 131, the noise transmitted from the driving coil 131 to the solenoid 140 may be reduced.

Referring to FIG. 2, the reduction coil 150 according to an embodiment may include a magnetic shielding coil 160 that surrounds the control rod driving shaft 120 and cancels out a magnetic field generated from the driving coil 131.

The magnetic shielding coil 160 may be a coil surrounding the control rod driving shaft 120, and the magnetic shielding coil 160 may be provided between the solenoid 140 and the driving coil 131.

The magnetic shielding coil 160 may have the function of shielding magnetic field noise affecting the solenoid 140 by canceling out the magnetic field generated from the driving coil 131.

According to an embodiment, the magnetic shielding coil 160 may cancel out the magnetic field generated from the driving coil 131 in an active or passive manner.

Specifically, no current may be applied to the magnetic shielding coil 160, and by placing the magnetic shielding coil 160 between the solenoid 140 and the driving coil 131, the magnetic field generated from the driving coil 131 may be passively canceled.

In addition, according to an embodiment, a current having a phase opposite to that of the current applied to the driving coil 131 may be applied to the magnetic shielding coil 160.

According to an embodiment, a pulse current may be applied to the driving coil 131, and a current with a phase opposite to the current applied to the driving coil 131 may be applied to the magnetic shielding coil 160.

In this way, by applying a current with a phase opposite to the current applied to the driving coil 131 to the magnetic shielding coil 160, the magnetic field generated by the driving coil 131 may be canceled out.

However, the method of canceling the magnetic field generated by the driving coil 131 through the magnetic shielding coil 160 according to an embodiment is not limited thereto, and the magnetic shielding coil 160 may be arranged between the solenoid 140 and the driving coil 131 to cancel the magnetic field generated by the driving coil 131 in various ways.

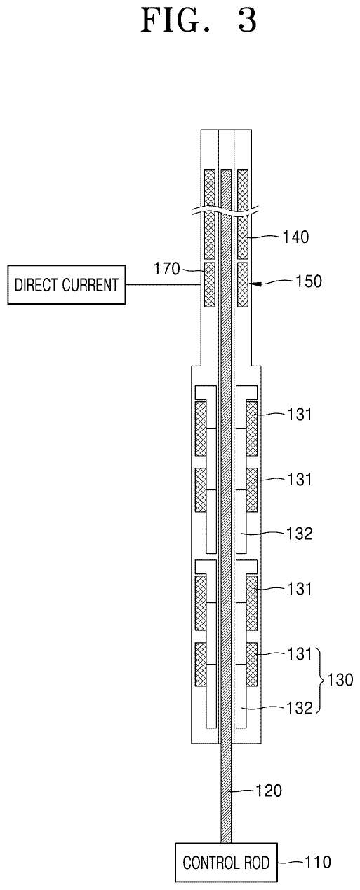

Referring to FIG. 3, the reduction coil 150 according to an embodiment may include a permeability control coil 170 surrounding the control rod driving shaft 120. The permeability control coil 170 according to an embodiment may be a coil surrounding the control rod driving shaft 120, and the permeability control coil 170 may be provided between the solenoid 140 and the driving coil 131.

According to an embodiment, a direct current (DC) may be applied to the permeability control coil 170, and by applying the DC to the permeability control coil 170, changes in the permeability of the control rod driving shaft 120 may be suppressed through the permeability control coil 170.

Specifically, the permeability of the control rod driving shaft 120 may change over time due to the current flowing in the driving coil 131, but by providing the permeability control coil 170, to which the DC is applied, between the solenoid 140 and the driving coil 131, changes in the permeability of the control rod driving shaft 120 may be suppressed.

In this way, the noise reduction apparatus for a control rod position indicator, according to an embodiment, may suppress noise transmission from the driving coil 131 to the solenoid 140 by providing the reduction coil 150, which includes the magnetic shielding coil 160 and the permeability control coil 170, between the solenoid 140 and the driving coil 131.

The noise reduction apparatus for a control rod position indicator, according to an embodiment, may improve the accuracy of position measurement of the control rod 110 in a solenoid-type control rod position indicator capable of continuously measuring the position of the control rod 110 by suppressing noise transmission from the driving coil 131 to the solenoid 140.

FIG. 2 illustrates the magnetic shielding coil 160 arranged between the solenoid 140 and the driving coil 131 according to an embodiment, and FIG. 3 illustrates the permeability control coil 170 to which a DC is applied and which is positioned between the solenoid 140 and the driving coil 131 according to an embodiment.

Referring to FIGS. 2 and 3, either the magnetic shielding coil 160 or the permeability control coil 170 may be provided between the solenoid 140 and the driving coil 131 according to an embodiment.

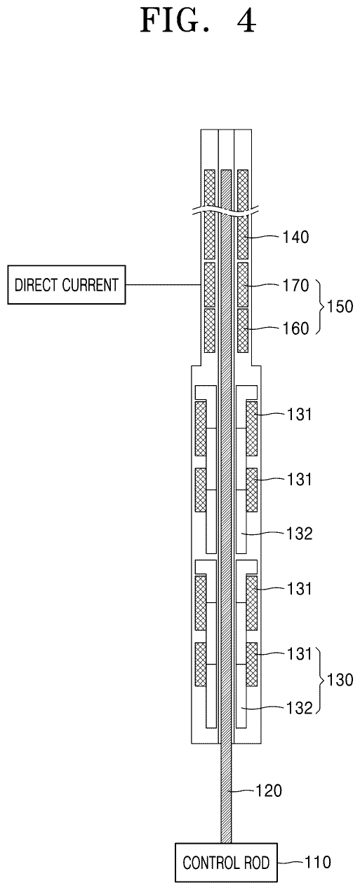

However, the disclosure is not limited thereto, and both the magnetic shielding coil 160 and the permeability control coil 170 may be provided between the solenoid 140 and the driving coil 131 according to an embodiment as shown in FIG. 4.

The noise reduction apparatus for a control rod position indicator according to the embodiment described above has the following effects.

According to the noise reduction apparatus for a control rod position indicator according to an embodiment, the accuracy of control rod position measurement may be improved by reducing, by using a reduction coil, noise generated by a driving coil in the control rod position indicator including a solenoid that continuously measures a control rod position.

According to the noise reduction apparatus for the control rod position indicator according to an embodiment, the accuracy of control rod position measurement may be improved by removing noise caused by a magnetic field generated by a driving coil through a magnetic shielding coil in the control rod position indicator including a solenoid capable of continuously measuring a control rod position.

According to the noise reduction apparatus for a control rod position indicator according to an embodiment, the accuracy of control rod position measurement may be improved by suppressing changes in the permeability of a control rod driving shaft through a permeability control coil in the control rod position indicator including a solenoid capable of continuously measuring a control rod position.

According to the noise reduction apparatus for a control rod position indicator according to an embodiment, a nuclear reactor in a nuclear power plant may be stably operated by improving the accuracy of control rod position measurement, thus contributing to an efficient operation of a nuclear power plant.

The disclosure relates to the noise reduction apparatus for a control rod position indicator. According to the disclosure, the accuracy of control rod position measurement may be improved by reducing noise generated by a driving coil by using a reduction coil in the control rod position indicator, which includes a solenoid capable of continuously measuring a control rod position.

According to the disclosure, the accuracy of control rod position measurement may be improved by reducing noise caused by a magnetic field generated by a driving coil through a magnetic shielding coil in the control rod position indicator, which includes a solenoid capable of continuously measuring a control rod position.

According to the disclosure, the accuracy of control rod position measurement may be improved by suppressing changes in the permeability of a control rod driving shaft through a permeability control coil in the control rod position indicator, which includes a solenoid capable of continuously measuring the control rod position.

According to the disclosure, a nuclear reactor in a nuclear power plant may be stably operated by improving the accuracy of control rod position measurement, thereby contributing to an efficient operation of the nuclear power plant.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A noise reduction apparatus for a control rod position indicator for measuring a position of a control rod, the noise reduction apparatus comprising:
a control rod driving shaft connected to the control rod and configured to move in an up-and-down direction;
a drive unit including a driving coil surrounding an outside of the control rod driving shaft and configured to move the control rod driving shaft;
a solenoid spaced apart from the drive unit and surrounding the outside of the control rod driving shaft, wherein inductance of the solenoid changes due to a movement of the control rod driving shaft; and
a reduction coil configured to reduce noise transmitted from the driving coil to the solenoid.

2. The noise reduction apparatus of claim 1, wherein one solenoid extending in a longitudinal direction is provided outside the control rod driving shaft, and
the one solenoid continuously measures a position of the control rod driving shaft through changes in the inductance of the one solenoid.

3. The noise reduction apparatus of claim 1, wherein the control rod driving shaft comprises a magnetic material and the inductance of the solenoid changes in response to the movement of the control rod driving shaft.

4. The noise reduction apparatus of claim 1, wherein the reduction coil is provided between the solenoid and the driving coil.

5. The noise reduction apparatus of claim 4, wherein the reduction coil comprises a magnetic shielding coil surrounding the control rod driving shaft and cancelling out a magnetic field generated by the driving coil.

6. The noise reduction apparatus of claim 5, wherein no current is applied to the magnetic shielding coil.

7. The noise reduction apparatus of claim 5, wherein a current having a phase opposite to that of a current applied to the driving coil is applied to the magnetic shielding coil.

8. The noise reduction apparatus of claim 4, wherein the reduction coil includes a permeability control coil surrounding the control rod driving shaft, and
a direct current (DC) current is applied to the permeability control coil.

9. The noise reduction apparatus of claim 1, wherein the drive unit includes a driving motor comprising an electromagnet, and
the driving coil surrounds the driving motor.
